(19) United States
(12) Patent Application Publication
(10) Pub. No.: US 2025/0154880 A1
(43) Pub. Date: May 15, 2025

(54) BEARING CARRIER SUPPORT WITH REDUCED AXIAL LENGTH

(71) Applicant: ROLLS-ROYCE plc, London (GB)

(72) Inventors: Craig TOWN, Bristol (GB); Jason J. MADGE, Gloucester (GB)

(73) Assignee: ROLLS-ROYCE plc, London (GB)

(21) Appl. No.: 19/022,341

(22) Filed: Jan. 15, 2025

Related U.S. Application Data
(63) Continuation of application No. 18/327,507, filed on Jun. 1, 2023.

(30) Foreign Application Priority Data
Jun. 14, 2022 (GB) 2208667.2

(51) Int. Cl. F01D 25/16; F16C 27/04

(52) U.S. Cl. CPC F01D 25/164; F01D 25/162; F16C 27/045; F05D 2220/32; F16C 2360/23

(57) ABSTRACT

A bearing carrier support for connecting a rotary shaft of a gas turbine engine to a static portion of the gas turbine engine. The bearing carrier support has: a bearing portion for supporting the rotary shaft; a flange portion for attaching the bearing carrier support to the static portion of the gas turbine engine; and a support portion that connects the flange portion and the bearing portion. The support portion has a plurality of circumferentially distributed struts that are axially aligned with respect to the rotary shaft. A snubber extends from either the flange portion or bearing portion to form an abutment face.

### CROSS-REFERENCE TO RELATED APPLICATIONS

This application is a continuation of U.S. application Ser. No. 18/327,507 filed on Jun. 1, 2023, which claims priority from United Kingdom patent application number GB 2208667.2 filed on Jun. 14, 2022. The entire contents of each of these applications is incorporated herein by reference.

### BACKGROUND

### Technical Field

The present disclosure relates to a bearing carrier support, more specifically a bearing carrier support that provide a semi-flexible support to the rotor axial location (e.g. ball) bearing, used in conjunction with a squeeze film damper, for a rotary shaft of a gas turbine engine.

### Description of the Related Art

A bearing carrier support is a component designed to provide a semi-flexible support to the rotor axial location bearing, typically a ball bearing and used in conjunction with a squeeze film dampener, for a rotating shaft, e.g. of a gas turbine engine.

A bearing carrier support typically has a series of spring bars arrayed circumferentially in between a pair of flanges. The flanges locate the bearing in the housing/structure.

The radial stiffness of the bearing carrier support is generally such that it will support the rotor under normal operating conditions, but when the rotor exhibits vibration, due to out of balance or crossing a mode in the running range, the squeeze film dampener is activated and the energy is transferred in the squeeze film. The axial stiffness needs to be very high to react the thrust loads.

The bearing carrier support is typically arranged so that the axial loads are taken along the bars in tension and the radial loads taken perpendicular to the bars resulting in bending. The length and cross section of spring bars is driven by separate axial and radial stiffness requirements, which lend them to be long slender spring bars. The minimum achievable length is constrained by the need to achieve the desired radial stiffness whilst limiting bar bending stresses due to squeeze film dampener orbit.

These requirements result in relatively long bearing carriers, which increases engine centreline length. That is a significant driver of engine weight, which is undesirable in aerospace applications as weight increases specific fuel consumption (SPC). The components also tend to be expensive as they need to be machined into relatively long slender bars or precision assembled. This limits the opportunity for weight, cost and space envelope reduction much beyond what has already been achieved.

U.S. Pat. No. 7,857,519 B2 discloses a compact squirrel-cage bearing support that has a plurality of beams interconnecting a first end portion to a second end portion. The length of the beams is greater than the axial spacing between the first end portion and the second end portion.

German patent application DE 202010206588 A1 discloses a bearing carrier for support of a rotary bearing of a rotating shaft of a gas turbine, e.g. flight gas turbine, having a flange portion with a supporting structure of the gas turbine, a bearing section, in which at least one rotary bearing is receivable, and with a cage portion in the axial direction of the bearing carrier between the flange portion and the bearing portion is arranged, and a plurality of circumferentially distributed strut. The flange portion and the bearing section are connected to one another.

There is however a need for an improved bearing carrier support or at least a bearing carrier support that provides a useful alternative to known bearing carrier supports.

### SUMMARY

In a first aspect there is provided a bearing carrier support for connecting a rotary shaft of a gas turbine engine to a static portion of the gas turbine engine, the bearing carrier support comprising: a bearing portion for supporting the rotary shaft; a flange portion for attaching the bearing carrier support to the static portion of the gas turbine engine; and a support portion that connects the flange portion and the bearing portion, the support portion comprising a plurality of circumferentially distributed struts that are axially aligned with respect to the rotary shaft; wherein the number of struts is at least 500 and the diameter of each strut is no more than 3 mm.

In some embodiments the diameter of each strut is no more than 1.5 mm.

In some embodiments the diameter of each struct is no more than 0.5 mm.

In some embodiments the diameter of each strut is equal.

In some embodiments the number of struts is at least 1000.

In some embodiments the number of struts is at least 5000.

In some embodiments the struts have a constant diameter along their axial length.

In some embodiments the struts are non-continuously distributed such that there are gaps within the circumferential distribution.

In some embodiments the struts comprise steel, titanium, carbon fibre, or composite reinforced rods.

In some embodiments the struts are welded, bonded or trapped between the flange portion and the bearing portion.

In some embodiments at least one snubber extends from the bearing portion to provide a hard stop against the flange portion.

In some embodiments at least one anti-rotational stop extends from the flange portion to provide a hard stop against a side face of the snubber.

In some embodiments the bearing carrier support is manufactured using Additive Layer Manufacturing.

In a second aspect there is provided a gas turbine engine that includes a bearing carrier support of the first aspect.

Throughout this specification and in the claims that follow, unless the context requires otherwise, the word “comprise” or variations such as “comprises” and “comprising”, will be understood to imply the inclusion of a stated integer or group of integers but not the exclusion of any other stated integer or group of integers.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### DESCRIPTION OF THE DRAWINGS

Embodiments will now be described by way of example only, with reference to the Figures, in which:

FIG. 1 is a sectional side view of a gas turbine engine, more particularly a geared turbofan aircraft engine;

FIG. 2 is a close-up sectional side view of an upstream portion of the gas turbine engine shown in FIG. 1;

FIG. 3 is a partially cut-away view of a gearbox for the gas turbine engine show in FIGS. 1 and 2;

FIG. 4 is a side view of a first embodiment of the bearing carrier support of the present disclosure.

FIG. 5 is a sectional perspective view of the bearing carrier support of FIG. 4.

FIG. 6 is a sectional perspective view of a second embodiment of the bearing carrier support of the present disclosure where the array of struts has intermediate gaps.

FIG. 7 is a sectional perspective view of a third embodiment of the bearing carrier support of the present disclosure where the arrays of struts comprises struts of varying diameter.

FIG. 8 is a close-up view of the part of the bearing carrier support in the elliptical region shown in FIG. 7 from which the struts of varying diameter are more clearly seen.

FIG. 9 is a side view of a fourth embodiment of the bearing carrier support of the present disclosure that includes a circumferential snubber.

FIG. 10 is a sectional perspective view of a fifth embodiment of the bearing carrier support of the present disclosure that includes a plurality of snubbers.

FIG. 11 is a side view of the sixth embodiment of the bearing carrier support of the present disclosure that includes anti-rotational stops.

The following table lists the reference numerals used in the drawings with the features to which they refer:

| Ref no. | Feature | FIG. |
|---|---|---|
| A | Core airflow | 1 |
| B | Bypass airflow | 1 |
| 9 | Principal and rotational axis (of engine) | 1, 2 |
| 10 | Gas turbine engine | 1 |
| 11 | Engine core | 1 |
| 12 | Air intake | 1 |
| 14 | Low pressure compressor | 1 |
| 15 | High pressure compressor | 1 |
| 16 | Combustion equipment | 1 |
| 17 | High pressure turbine | 1 |
| 18 | Bypass exhaust nozzle | 1 |
| 19 | Low pressure turbine | 1 |
| 20 | Core exhaust nozzle | 1 |
| 21 | Fan nacelle | 1 |
| 22 | Bypass duct | 1 |
| 23 | Fan | 1, 2 |
| 24 | Stationary supporting structure | 2 |
| 26 | Shaft | 1, 2, 4 |
| 27 | Shaft | 1, 4 |
| 28 | Sun gear | 2 |
| 30 | Epicyclic gearbox | 1, 2 |
| 32 | Planet gear | 2 |
| 34 | Planet carrier | 2 |
| 36 | Linkage | 2 |
| 38 | Ring gear | 2 |
| 40 | Linkage | 2 |
| 50 | Bearing carrier support | 4, 5, 6, 7, 8 |
| 60 | Bearing portion | 4, 5, 6, 7, 8 |
| 70 | Flange portion | 4, 5, 6, 7, 8 |
| 80 | Support portion | 4, 5, 6, 7, 8 |
| 90 | Static portion | 4 |
| 100 | Array of struts | 4, 5, 6, 7, 8 |
| 110 | Individual strut | 4, 5, 6, 7, 8 |
| 120 | Snubber | 9, 10, 11 |
| 130 | Anti-rotational stop | 11 |

### DETAILED DESCRIPTION

Aspects and embodiments of the present disclosure will now be discussed with reference to the accompanying figures. Further aspects and embodiments will be apparent to those skilled in the art.

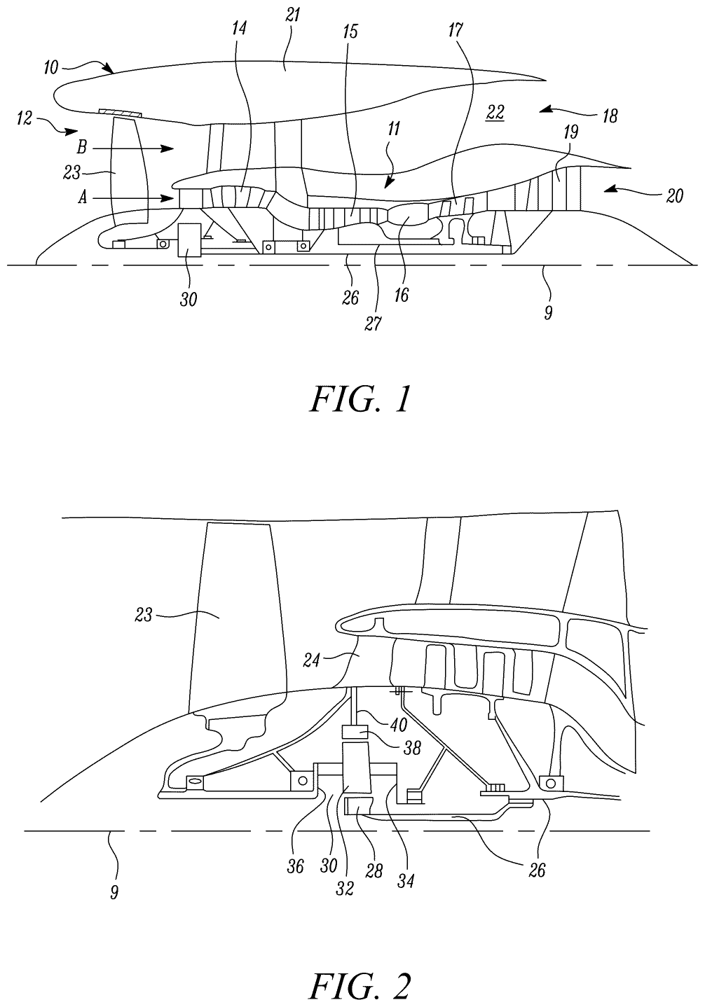

The present disclosure provides a bearing carrier support, for example, to provide a semi-flexible support to the rotor axial location (e.g. ball) bearing, used in conjunction with a squeeze film dampener, for a rotating shaft of a gas turbine engine. FIGS. 1, 2 and 3 describe a gas turbine engine for which the bearing carrier of the present disclosure is suitable for use, although the person skilled in the art would appreciate the bearing carrier support could be used to support the rotor axial location of a shaft of any gas turbine engine or indeed a shaft of any machine or apparatus.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

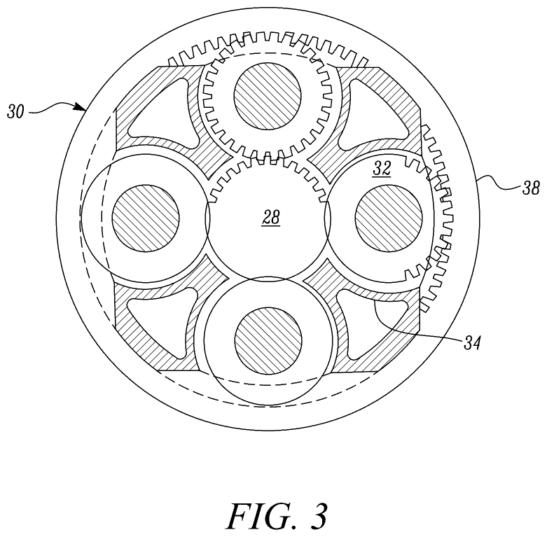

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

The present disclosure concerns a bearing carrier support that is, for example, to provide a semi-flexible support to the rotor axial location (e.g. ball) bearing, used in conjunction with or without a squeeze film dampener, for a rotating shaft of a gas turbine engine.

In broad terms the bearing carrier support 50 of the present disclosure comprises a bearing portion 60, a flange portion 70 and a support portion 80.

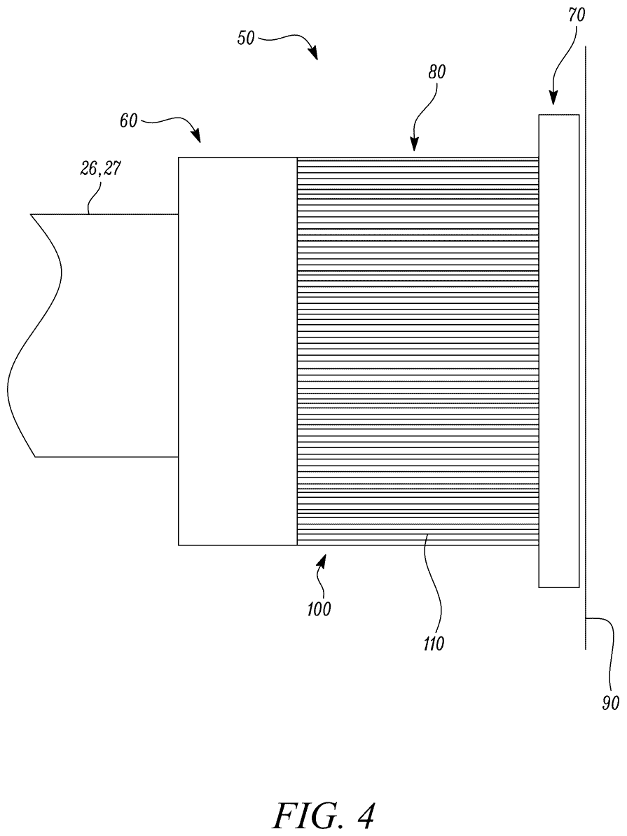

A first embodiment of such a bearing carrier support is shown in FIG. 4.

The bearing carrier support 50 interconnects the rotating shafts 26, 27 of a gas turbine engine with the static portion 90 of the gas turbine engine. Under normal engine operating conditions, the bearing carrier support 50 supports the shafts 26,27 in their axial position.

The bearing portion 60 is configured to receive a bearing (not shown) and the bearing locates the rotary shafts 26, 27. The bearing portion can be any suitable form for that purpose, for example, an annular section. The bearing portion 60 can be formed out of any suitable material for its purpose, for example metallic or composite. The bearing portion 60 is designed to house a bearing allowing the shaft 26,27 of the turbine engine to rotate.

The flange portion 70 attaches the bearing carrier support 50 to a static portion 90 of a gas turbine engine 10. The flange portion 70 can be any suitable form for that purpose, for example can be annular. The flange portion 70 can be formed from any suitable material for its purpose, for example metal or composite. The flange portion 70 may have a plurality of holes that correspond to holes within the gas turbine structure 90. The flange portion 70 can be removable fixed to the gas turbine structure with fixings, e.g. bolts. The flange portion 70 may be permanently fixed to the gas turbine structure, e.g. welded. The flange portion 70 is connected to the static portion 90 of the gas turbine engine 10 so that the shaft 26,27 is axially position.

The bearing (including the carrier support element) is typically located within a bearing housing which is located within or integral to a bearing support structure, or static structure. This transfers the bearing loads out to the casings and then airframe, via the engine mounts.

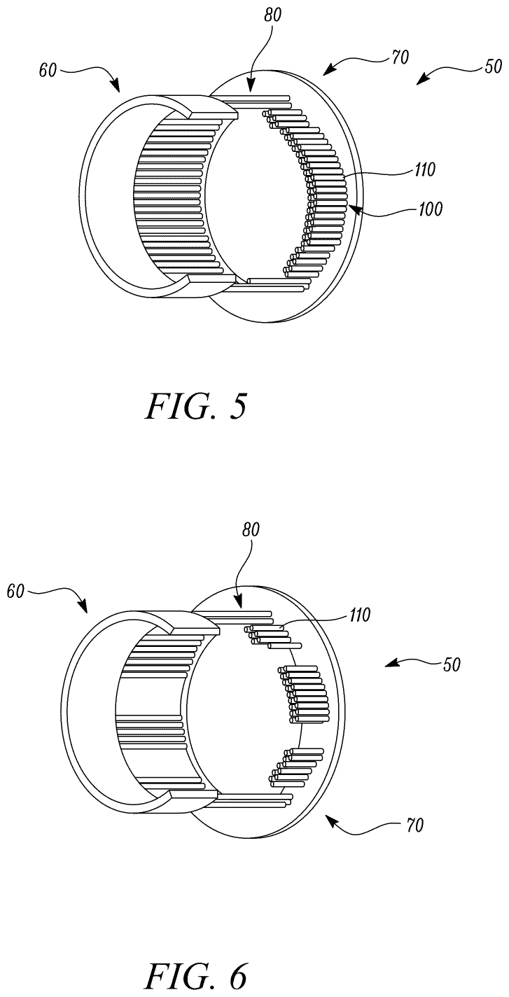

The support portion 80 connects the flange portion 70 and the bearing portion 60. The support portion 80 comprises a plurality of circumferentially distributed struts 100, shown in FIG. 5, that are axially aligned with respect to the rotary shaft 26,27. The struts 100 extend axially between the bearing portion 60 and the flange portion 70 and attach at their distal ends. Loads are typically absorbed through the squeeze film dampener and then absorbed.

The number of struts 100 is at least 500, for example from 500 to 1000 or from 500 and 5000. The struts 100 may be formed from any suitable material, for example metallic or composite. The struts 100 may not be the same material, for example an individual struts 110 in an array of struts 100 may be different materials.

The diameter of the individual strut 110 may be no more than 3 mm, for example from 1.5 mm to 3.0 mm or from 0.5 mm to 3.0 mm. The diameter of the individual strut 110 may or may not vary along its length. The individual strut 110 in an array of struts 100 may have the same or different diameters. In the example shown at FIGS. 4 and 5 the individual struts 110 have a constant diameter and are all equal.

The array of struts 100 may be distributed uniformly or non-uniformly.

In a second embodiment of the bearing carrier support 50 of the present disclosure the array of struts 100 is positioned in separate bundles, as shown in FIG. 6. The bundles may consist of the same or different numbers of individual struts 110. The bundles may be distributed uniformly of non-uniformly.

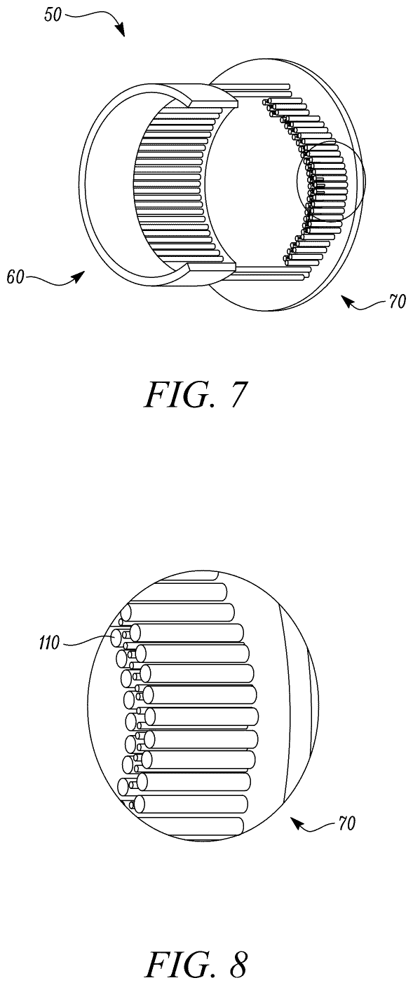

In a third embodiment of the bearing carrier support 50 of the present disclosure shown in FIG. 7 the individual struts 110 have different diameters. The variation in strut diameters is shown more clearly in FIG. 8, which is a close-up view of the elliptical area shown in FIG. 7. In the third embodiment, the individual struts 110, while varying in diameter, are all circular in diameter. Alternatively, the individual struts 110 may have a cross section that is not circular, for example they may be square, oval or elliptical in cross-section. The individual struts 110 may be specifically designed to react the vibration modes of the rotating shaft 26,27. The individual struts 110 may be specifically designed to be stiffer in one direction over the other direction. The individual struts 110 may be specifically designed to reduce the overall size and improve the packaging within the design space.

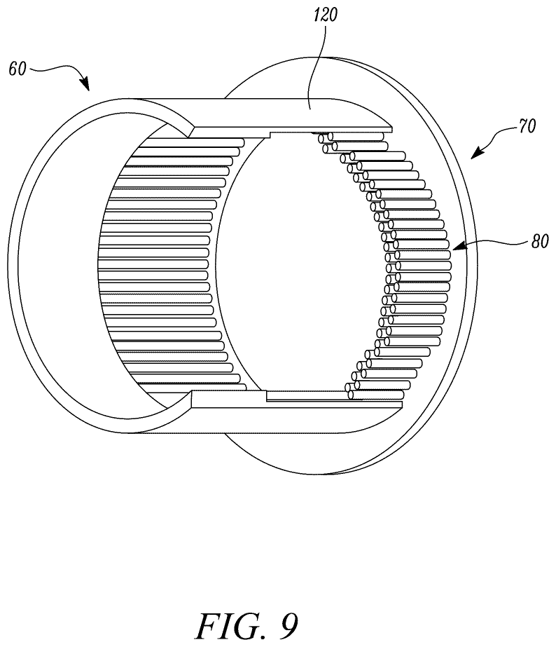

FIG. 9 shows a fourth embodiment of the bearing carrier support 50 of the present disclosure. This embodiment resembles the first embodiment except it has a snubber 120. In this embodiment there is a single snubber 120 in the form of a continuous ring that extends from the bearing portion 60 to form an abutment face that is engageable with the flange portion 70. The snubber 120 limits the deformation of the individual struts 110 by providing a hard stop between the bearing portion 60 and the flange portion 70 if an overload is encountered that may cause buckling of the individual struts 110, allowing the overload to bypass the array of struts 100. In alternative embodiments the snubber 120 may extend from the flange portion 70 to form an abutment face that is engageable with the bearing portion 60. The distance between the abutment face of the snubber 120 and the corresponding bearing portion 60 or flange portion 70 may be less than 1 mm. In the embodiment shown in FIG. 9 the snubber 120 is radially external to the array of struts 100. In other embodiments the snubber 120 may be radially internal to the array of struts 100. In other embodiments the snubber 120 may be interspersed within the array of struts 110.

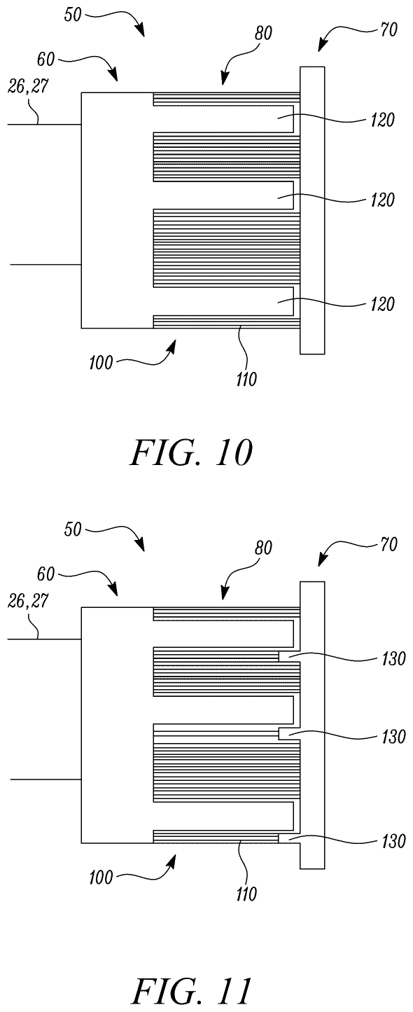

FIG. 10 shows a fifth embodiment of the bearing carrier support 50 of the present disclosure. In this embodiment a plurality of snubbers 120 extend from the bearing portion 60 to form an abutment face that is engageable with the flange portion 70. In alternative embodiments the plurality of snubbers 120 may extend from the flange portion 70 to form an abutment face that is engageable with the bearing portion 60. In the embodiment shown in FIG. 10 the plurality of snubbers 120 is integral with the bearing portion 60 and is therefore formed of the same material. In another embodiment the plurality of snubbers 120 is not integral with the bearing portion 60 and so the plurality of 120 snubbers and the bearing portion 60 can be formed of different material, for example, the plurality of snubbers 120 may be formed of a hard rubber and the bearing portion 60 may be formed of a metal. The plurality of snubbers 120 may be positioned intermittently around the circumference of the flanges. The intermittent plurality of snubbers 120 may be equally spaced.

FIG. 11 shows a sixth embodiment of the bearing carrier support 50 of the present disclosure. In this embodiment anti-rotational stops 130 extend from the flange portion 70 to form an abutment face that is engageable with the side face of the snubbers 120. The anti-rotational stops 130 prevent a circumferential twisting of the array of struts 100 by providing a hard stop between the snubber 120 of the bearing portion 60 and the anti-rotational stop 130 of the flange portion 70 if an overload is encountered that may cause buckling of the array of struts 100, allowing the overload to bypass the array of struts 110. In alternative embodiments the anti-rotational stop 130 may extend from the bearing portion 60 to form an abutment face that is engageable with side face of the snubbers 120 that extend from the flange portion 70. The distance between the abutment face of the anti-rotational stop 130 and the side face of the corresponding snubber 120 may be less than 1 mm.

Bearing carrier supports 50 of the present disclosure may be fabricated using a conventional manufacturing process, an additive layer manufacturing (ALM) technique or a combination of these. The bearing carrier support 50 may be manufactured from any suitable material or combination of materials selected based on the specific application. The bearing portion 60, the flange portion 70 and the support portion 80 may be the same material of different material. The individual struts 110 may be bonded, welded, co-cured (if composite) or trapped.

The bearing carrier support 50 allows for the resilient radial movement of the bearing (not shown) in response to the radial forces that are induced by the vibrations of the rotating shaft 26,27. The bearing carrier support 50 also provide a self-centring support for the shaft 26,27. The bearing carrier support 50 provides a support with high axial stiffness but low radial and torsional stiffnesses.

Depending on the dynamic properties required, the bearing carrier support 50 may comprise a combination of different arrays of struts 100. The size, number and spacing of the individual struts 110 may be selected on factors such as material properties, operating conditions and dynamic properties required for the bearing carrier support 50. Conventional numerical simulation and modelling techniques commonly used in the art may be used to determine a suitable design configuration of the bearing carrier support 50.

This provides a bearing carrier support 50 with a reduced weight and axial length when compared to existing designs. The aspect ratio and arrangement of the array of struts 100 makes them radially compliant, thus stresses can be kept low for a given orbit size and individual strut 110 length. Adequate radial and axial stiffness is achieved by increasing the total individual strut 110 count. This results in reduced component size (particularly axial length) and weight, whilst maintaining the current ability to achieve different axial and radial stiffness targets. The reduction in size allows the bearing carrier support 50 to be integrated into the bearing with an overall reduction in required axial length.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A bearing carrier support for connecting a rotary shaft of a gas turbine engine to a static portion of the gas turbine engine, the bearing carrier support comprising:
a bearing portion for supporting the rotary shaft;
a flange portion for attaching the bearing carrier support to the static portion of the gas turbine engine; and
a support portion that connects the flange portion and the bearing portion, the support portion comprising a plurality of circumferentially distributed struts that are axially aligned with respect to the rotary shaft;
wherein at least one snubber extends from either the bearing portion or the flange portion to form an abutment face.

2. The bearing carrier support of claim 1, wherein the at least one snubber forms a continuous ring.

3. The bearing carrier support of claim 1, wherein the at least one snubber includes a plurality of snubbers with gaps between each snubber.

4. The bearing carrier support of claim 3, wherein at least one anti-rotational stop extends from either the bearing portion or the flange portion to provide a hard stop against at least one side face of at least one of the plurality of snubbers.

5. The bearing carrier support of claim 4, wherein the distance between the at least one anti-rotational stop and the at least one side face of the at least one plurality of snubbers is less than 1 mm.

6. The bearing carrier support of claim 1, wherein the distance between the abutment face and either the bearing portion or the flange portion is less than 1 mm.

7. The bearing carrier support of claim 1, wherein the snubber is radially external to the plurality of circumferentially distributed struts.

8. The bearing carrier support of claim 1, wherein the snubber is radially internal to the plurality of circumferentially distributed struts.

9. The bearing carrier support of claim 1, wherein the snubber is interspersed within the plurality of circumferentially distributed struts.

10. A gas turbine engine that includes the bearing carrier support of claim 1.

11. The bearing carrier support of claim 1, wherein the struts are non-continuously distributed such that there are gaps within the circumferential distribution.

12. The bearing carrier support of claim 11, wherein the plurality of circumferentially distributed struts are positioned in separate bundles consisting of equal numbers of individual struts.

13. The bearing carrier support of claim 11, wherein the plurality of circumferentially distributed struts are positioned in separate bundles consisting of different numbers of individual struts.

14. The bearing carrier support of claim 11, wherein the plurality of circumferentially distributed uniformly.

15. The bearing carrier support of claim 11, wherein the plurality of circumferentially distributed non-uniformly.

16. The bearing carrier support of claim 1, wherein at least some of the plurality of circumferentially distributed struts vary in diameter.

17. The bearing carrier support of claim 16, wherein at least some of the plurality of circumferentially distributed struts are stiffer in one direction over another direction.

18. The bearing carrier support of claim 16, wherein at least some of the individual struts of the plurality of circumferentially distributed struts are designed to react to a vibration mode of the rotary shaft.
